(19) United States
(12) Patent Application Publication
(10) Pub. No.: US 2026/0196217 A1
(43) Pub. Date: Jul. 9, 2026

(54) INFORMATION PROCESSING DEVICE, OPERATION METHOD FOR INFORMATION PROCESSING DEVICE, AND NON-TRANSITORY STORAGE MEDIUM FOR INFORMATION PROCESSING DEVICE

(71) Applicant: TOYOTA JIDOSHA KABUSHIKI KAISHA, Toyota-shi (JP)

(72) Inventors: Hideki KAWAI, Tokyo (JP); Takuma SUZUKI, Tokyo (JP)

(73) Assignee: TOYOTA JIDOSHA KABUSHIKI KAISHA, Toyota-shi (JP)

(21) Appl. No.: 19/438,787

(22) Filed: Jan. 2, 2026

(30) Foreign Application Priority Data
Jan. 8, 2025 (JP) 2025-003060

(51) Int. Cl. G10L 15/22; G06F 16/63; G10L 15/18; G10L 15/30

(52) U.S. Cl. CPC G10L 15/22; G06F 16/63; G10L 15/1815; G10L 15/30

(57) ABSTRACT

An information processing device includes: a storage unit configured to associate and store information about a first utterance of a person in charge when the person in the charge hears a need of a customer during a business talk with the customer, and information about a second utterance of the customer indicating the need; and a control unit configured to output the information about the first utterance and the information about the second utterance depending on a search condition.

### CROSS-REFERENCE TO RELATED APPLICATION

This application claims priority to Japanese Patent Application No. 2025-003060 filed on January 8, 2025. The disclosure of the above-identified application, including the specification, drawings, and claims, is incorporated by reference herein in its entirety.

### BACKGROUND

### 1. Technical Field

The present disclosure relates to an information processing device, an operation method for an information processing device, , and a non-transitory storage medium for an information processing device.

### 2. Description of Related Art

In a variety of businesses, the skillfulness of a business talk for encouraging a customer to purchase a product depends on an individual skill of a person in charge of sales, and therefore, various technologies for assisting the improvement in the skill of the person in charge for the business talk have been proposed. For example, Japanese Unexamined Patent Application Publication No. 2019-28910 (JP 2019-28910 A) discloses a technology in which a dialogue that needs to be monitored is searched from the content of the explanation for the customer.

### SUMMARY

In a technology for assisting the improvement in the business talk skill of the person in charge of sales using machine learning or the like, there is room for improvement in training efficiency for the person in the charge of sales.

An information processing device and others that makes it possible to improve the training efficiency for the person in charge of sales will be disclosed below.

An information processing device according to a first aspect of the present disclosure includes: a storage unit configured to associate and store information about a first utterance of a person in charge when the person in the charge hears a need of a customer during a business talk with the customer and information about a second utterance of the customer indicating the need; and, a control unit configured to output the information about the first utterance and the information about the second utterance depending on a search condition.

In the information processing device according to the first aspect of the present disclosure, the storage unit may be configured to further store information about a third utterance when the person in the charge makes a proposal depending on the need, in association with the information about the first utterance and the information about the second utterance. The control unit may be configured to output the information about the third utterance together with the information about the first utterance and the information about the second utterance.

In the information processing device according to the first aspect of the present disclosure, the storage unit may be configured to further store information about a fourth utterance indicating intention of the customer about the proposal, in association with the information about the first utterance, the information about the second utterance, and the information about the third utterance. The search condition may be a search condition relevant to the intention. The control unit may be configured to output the information about the fourth utterance together with the information about the first utterance, the information about the second utterance, and the information about the third utterance.

In the information processing device according to the first aspect of the present disclosure, the information about the first utterance may include an audio of the first utterance extracted from an audio of the business talk by the control unit. The information about the second utterance may include an audio of the second utterance extracted from the audio of the business talk by the control unit.

In the information processing device according to the first aspect of the present disclosure, the control unit may be configured to generate the information about the first utterance and the information about the second utterance from an audio of the business talk and store the information about the first utterance and the information about the second utterance in the storage unit.

In the information processing device according to the first aspect of the present disclosure, the control unit may be configured to generate the information about the third utterance from an audio of the business talk and store the information about the third utterance in the storage unit.

In the information processing device according to the first aspect of the present disclosure, the control unit may be configured to generate the information about the fourth utterance from an audio of the business talk and store the information about the fourth utterance in the storage unit.

A second aspect of the present disclosure is an operation method for an information processing device configured to associate and store information about a first utterance of a person in charge when the person in the charge hears a need of a customer during a business talk with the customer and information about a second utterance of the customer indicating the need. The operation method includes outputting the information about the first utterance and the information about the second utterance depending on a search condition.

The operation method for the information processing device according to the second aspect of the present disclosure may include: storing information about a third utterance when the person in the charge makes a proposal depending on the need, in association with the information about the first utterance and the information about the second utterance; and outputting the information about the third utterance together with the information about the first utterance and the information about the second utterance.

The operation method for the information processing device according to the second aspect of the present disclosure may include: storing information about a fourth utterance indicating intention of the customer about the proposal, in association with the information about the first utterance, the information about the second utterance, and the information about the third utterance; and outputting the information about the fourth utterance together with the information about the first utterance, the information about the second utterance, and the information about the third utterance. The search condition may be a search condition relevant to the intention.

In the operation method for the information processing device according to the second aspect of the present disclosure, the information about the first utterance may include an audio of the first utterance extracted from an audio of the business talk. The information about the second utterance may include an audio of the second utterance extracted from the audio of the business talk.

The operation method for the information processing device according to the second aspect of the present disclosure may include generating the information about the first utterance and the information about the second utterance from an audio of the business talk and storing the information about the first utterance and the information about the second utterance.

The operation method for the information processing device according to the second aspect of the present disclosure may include generating the information about the third utterance from an audio of the business talk and storing the information about the third utterance.

The operation method for the information processing device according to the second aspect of the present disclosure may include generating the information about the fourth utterance from an audio of the business talk and storing the information about the fourth utterance.

A third aspect of the present disclosure is a program for an information processing device configured to associate and store information about a first utterance of a person in charge when the person in the charge hears a need of a customer during a business talk with the customer and information about a second utterance of the customer indicating the need. The program for the information processing device includes outputting the information about the first utterance and the information about the second utterance depending on a search condition.

The program for the information processing device according to the third aspect of the present disclosure may include: storing information about a third utterance when the person in the charge makes a proposal depending on the need, in association with the information about the first utterance and the information about the second utterance; and outputting the information about the third utterance together with the information about the first utterance and the information about the second utterance.

The program for the information processing device according to the third aspect of the present disclosure may include: storing information about a fourth utterance indicating intention of the customer about the proposal, in association with the information about the first utterance, the information about the second utterance, and the information about the third utterance; and outputting the information about the fourth utterance together with the information about the first utterance, the information about the second utterance, and the information about the third utterance. The search condition may be a search condition relevant to the intention.

In the program for the information processing device according to the third aspect of the present disclosure, the information about the first utterance may include an audio of the first utterance extracted from an audio of the business talk by a control unit. The information about the second utterance may include an audio of the second utterance extracted from the audio of the business talk by the control unit

The program for the information processing device according to the third aspect of the present disclosure may include generating the information about the first utterance and the information about the second utterance from an audio of the business talk.

The program for the information processing device according to the third aspect of the present disclosure may include generating the information about the third utterance from an audio of the business talk.

A fourth aspect of the present disclosure is a non-transitory storage medium storing instructions that are executable by one or more processors included in an information processing device and that cause the one or more processors to perform functions, the information processing device being configured to associate and store information about a first utterance of a person in charge when the person in the charge hears a need of a customer during a business talk with the customer and information about a second utterance of the customer indicating the need. The functions include outputting the information about the first utterance and the information about the second utterance depending on a search condition.

In the non-transitory storage medium for the information processing device according to the fourth aspect of the present disclosure, the functions may include storing information about a third utterance when the person in the charge makes a proposal depending on the need, in association with the information about the first utterance and the information about the second utterance; and outputting the information about the third utterance together with the information about the first utterance and the information about the second utterance.

In the non-transitory storage medium for the information processing device according to the fourth aspect of the present disclosure, the functions may include: storing information about a fourth utterance indicating intention of the customer about the proposal, in association with the information about the first utterance, the information about the second utterance, and the information about the third utterance; and outputting the information about the fourth utterance together with the information about the first utterance, the information about the second utterance, and the information about the third utterance. The search condition may be a search condition relevant to the intention.

In the non-transitory storage medium for the information processing device according to the fourth aspect of the present disclosure, the information about the first utterance may include an audio of the first utterance extracted from an audio of the business talk by a control unit. The information about the second utterance may include the audio of the second utterance extracted from the audio of the business talk by the control unit

In the non-transitory storage medium for the information processing device according to the fourth aspect of the present disclosure, the functions may include generating the information about the first utterance and the information about the second utterance from an audio of the business talk.

In the non-transitory storage medium for the information processing device according to the fourth aspect of the present disclosure, the functions may include generating the information about the third utterance from an audio of the business talk.

The information processing device, the operation method for the information processing device, the program for the information processing device, and the non-transitory storage medium for the information processing device in the present disclosure make it possible to improve the training efficiency for the person in charge of sales.

### BRIEF DESCRIPTION OF THE DRAWINGS

Features, advantages, and technical and industrial significance of exemplary

embodiments of the disclosure will be described below with reference to the accompanying drawings, in which like signs denote like elements, and wherein:

FIG. 1 is a diagram showing an exemplary configuration of an information processing system;

FIG. 2 is a diagram for describing business-talk history information;

FIG. 3 is a flowchart showing an exemplary operation procedure of a server device;

FIG. 4 is a flowchart showing an exemplary operation procedure of the server device; and

FIG. 5 is a flowchart showing an exemplary operation procedure of the server device.

### DETAILED DESCRIPTION OF EMBODIMENTS

An embodiment of the present disclosure will be described below.

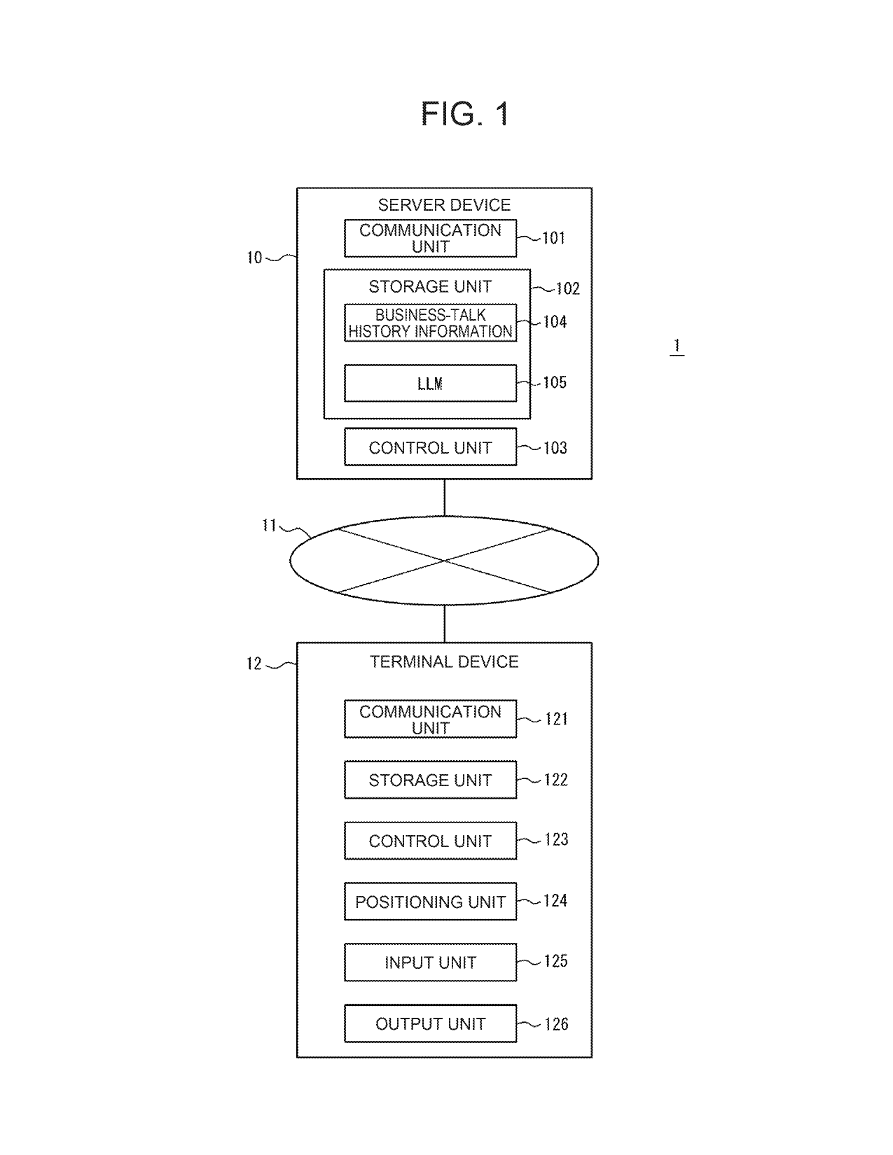

FIG. 1 is a diagram showing an exemplary configuration of an embodiment. An information processing system 1 includes one or more server devices 10 and one or more terminal devices 12 that are connected to server devices 10 through a network 11 such that information communication can be performed. For example, the server device 10 is constituted by one server computer, or a plurality of server computers that can perform information communication with each other, and the server computer is installed, for example, at one or more business offices of a vehicle seller, one or more datacenters, a cloud, or combinations of them, when appropriate. The server device 10 corresponds to an "information processing device" in the embodiment. For example, the terminal device 12 is constituted by one information processing device, or a plurality of information processing devices that can perform information communication with each other, and has a communication function and a voice input function. For example, the terminal device 12 is a personal computer, a portable tablet terminal device, a smartphone, or the like. For example, the terminal device 12 is installed at one or more business offices of the vehicle seller, when appropriate, and is used by a person in charge of sales. The terminal device 12 includes a communication interface for a mobile communication, a local area network (LAN), or the like, and is connected to the network 11 such that information communication can be performed. Further, the terminal device 12 includes a microphone that acquires the audio of the conversation between the person in charge of sales and a customer, and a processor that processes audio information. For example, the network 11 is a LAN in a business office, the internet, an ad-hock network, a metropolitan area network (MAN), a mobile communication network, another network, or combinations of them.

The information processing system 1 in the embodiment assists a business talk with a customer by a person in charge of sales of vehicles. The person in charge of sales performs various conversations during the business talk with the customer. The person in charge of sales hears a need of the customer, proposes a product that matches with the need, and encourage the customer to purchase the product when customer's understanding and consent for the product are formed. The product includes physical products such as a vehicle including a passenger car, a commercial car, an accessory of a vehicle, and a maintenance item, and services such as a maintenance service for a vehicle and a road service.

The server device 10 of the information processing system 1 includes a storage unit 102 and a control unit 103. The storage unit 102 stores business-talk history information 104 in which information (hereinafter referred to as derivation utterance information) about a first utterance (hereinafter referred to as a derivation utterance) of the person in charge when the person in charge hears the need of the customer during the business talk with the customer and information (hereinafter referred to as answer utterance information) about a second utterance (hereinafter referred to as an answer utterance) of the customer that indicates the need of the customer are associated. The control unit 103 outputs the information about the derivation utterance and the information about the answer utterance depending on a search condition. The person in charge of sales or a mentor thereof can search and learn, by an arbitrary search condition, the derivation utterance for obtaining the answer utterance in business talks by persons in charge of sales in the past, about a product that is a sales object, and therefore, can improve the training efficiency for the person in charge of sales.

Next, a communication unit 101, the storage unit 102, and the control unit 103 that are included in the server device 10 will be described. In the case where the server device 10 is constituted by a plurality of server computers, the communication unit 101, the storage unit 102, and the control unit 103 may be dispersedly disposed among the plurality of server computers, when appropriate.

The communication unit 101 includes one or more communication interfaces. For example, the communication interface is a LAN interface. The communication unit 101 receives information that is used for the operation of the server device 10, and sends information that is obtained by the operation of the server device 10. The server device 10 is connected to the network 11 by the communication unit 101, and performs information communication with the terminal device 12 via the network 11.

For example, the storage unit 102 includes a main storage device, an auxiliary storage device, one or more semiconductor memories that function as cache memories, one or more magnetic memories, one or more optical memories, or combinations of at least two kinds of them. For example, the semiconductor memory is a random access memory (RAM) or a read only memory (ROM). For example, the RAM is a static RAM (SRAM) or a dynamic RAM (DRAM). For example, the ROM is an electrically erasable programmable ROM (EEPROM). The storage unit 102 stores control and process programs necessary for the operation of the server device 10, a variety of information necessary for the execution of control and process programs by the server devices 10, and information obtained by the operation of the server device 10.

The control unit 103 includes one or more processors, one or more dedicated circuits, or combinations of them. For example, the processor is a general-purpose processor such as central processing unit (CPU), or a dedicated processor for a particular process, as exemplified by a graphics processing unit (GPU). For example, the dedicated circuit is a field-programmable gate array (FPGA), an application specific integrated circuit (ASIC), or the like. The control unit 103 executes information processing related to the operation of the server device 10, while controlling parts of the server device 10.

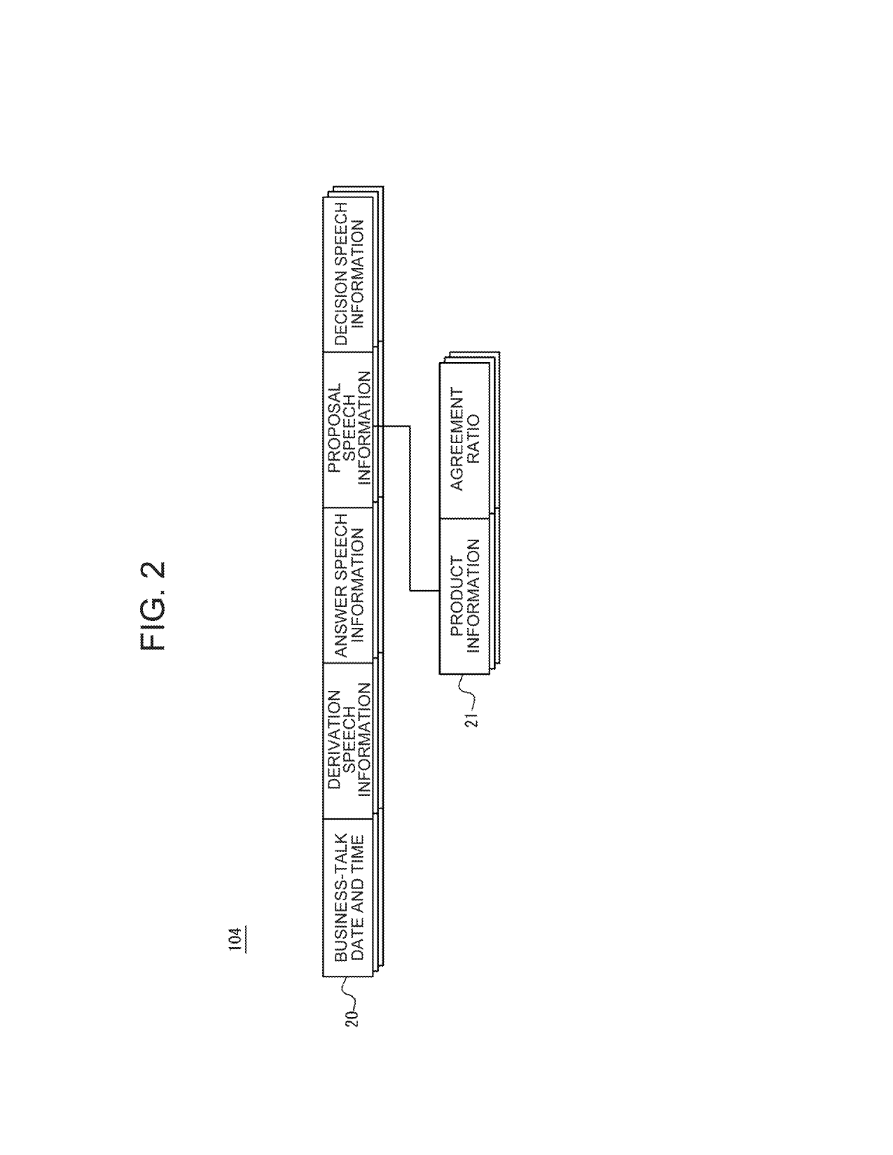

In the embodiment, the storage unit 102 stores the business-talk history information 104. As shown in FIG. 2, the business-talk history information 104 includes one or more business-talk histories 20. Each business-talk history 20 includes one or more combinations of business-talk date and time, derivation utterance information, answer utterance information, proposal utterance information, and decision utterance information.

The derivation utterance information includes information about the derivation utterance that is performed by the person in charge during the business talk for hearing the need of the customer, and includes the audio and text of the utterance, the summary of the utterance content, and pattern information indicating a pattern of the derivation. Examples of the pattern include a direct asking pattern in which the customer is directly asked about the need and an indirect asking pattern in which an idle talk for indirectly hearing the need is included.

The answer utterance information is information about the answer utterance that is relevant to the need and that is performed by the user during the business talk in response to the derivation utterance, and includes the audio and text of the utterance and the summary of the utterance content. The need includes the mind about the purchase, the family configuration, the utilization purpose of the vehicle, hobbies, life events, the living environment, and others.

The proposal utterance information is information about the utterance that is performed by the person in charge of sales during the business talk for making a proposal depending on the need of the user, and includes the audio and text of the utterance, the summary of the utterance content, and information about a product that is proposed. The proposal is a proposal of a product, and the product includes a vehicle such as a passenger car and a commercial car, an accessory of a vehicle, a maintenance item, a maintenance service for a vehicle, a road service, and others.

The decision utterance information is information indicating whether the customer agrees to or rejects the purchase of the product or service proposed by the person in charge during the business talk, and includes the audio and text of the utterance when the customer agrees to or reject the purchase of the product or service.

The business-talk history information 104 includes analysis information 21 that is derived from the business-talk histories 20. The analysis information 21 includes information about an agreement ratio for each product that is associated with product information. The agreement ratio is the ratio of the number of business-talk histories 20 in which the decision utterance information indicates the agreement to the purchase to the total number of business-talk histories 20 corresponding to a certain product. The product information in the business-talk history information 104 is associated with the information about the product that is included in the proposal utterance information in the business-talk history 20.

Referring back to FIG. 1, the storage unit 102 stores a large language model (LLM) 105. In the case where the server device 10 is constituted by a plurality of server computers, the LLM 105 may be stored in an arbitrary server computer, for example, a server computer that provides a cloud service. The LLM 105 is a model that has performed machine learning of natural language processes using a large volume of text data, and is a language model that can universally execute natural language processes such as information extraction, sentence summarization, and question-and-answer.

Next, an exemplary configuration of the terminal device 12 will be described.

The terminal device 12 includes a communication unit 121, a storage unit 122, a control unit 123, a positioning unit 124, an input unit 125, and an output unit 126.

The communication unit 121 includes a communication module that complies with a wired or wireless LAN standard, a module that complies with a mobile communication standard such as long term evolution (LTE), 4th generation (4G) or 5th generation (5G), and the like. By the communication unit 121, the terminal device 12 is connected to the network 11 through a router device in the vicinity or a base station for mobile communication, and performs information communication with another device via the network 11.

The storage unit 122 includes one or more semiconductor memories, one or more magnetic memories, one or more optical memories, or combinations of at least two kinds of them. For example, the semiconductor memory is a RAM or a ROM. For example, the RAM is an SRAM or a DRAM. For example, the ROM is an EEPROM. For example, the storage unit 122 functions as a main storage device, an auxiliary storage device, or a cache memory. The storage unit 122 stores information that is used for the operation of the control unit 123 and information that is obtained by the operation of the control unit 123. For example, the storage unit 122 may store control and process programs necessary for the operation of the terminal device 12, a variety of information necessary for the execution of control and process programs by the terminal device 12, and information obtained by the operation of the terminal device 12.

The control unit 123 includes one or more processors, one or more dedicated circuits, or combinations of them. The processor is a general-purpose processor such as a CPU or a dedicated processor for a particular process, as exemplified by a GPU. For example, the dedicated circuit is an FPGA or an ASIC. The control unit 123 executes information processing related to the operation of the terminal device 12, while controlling parts of the terminal device 12.

The positioning unit 124 includes one or more global navigation satellite system (GNSS) receivers. For example, the GNSS includes at least one of a global navigation satellite system (GPS), a quasi-zenith satellite system (QZSS), BeiDou, a global navigation satellite system (GLONASS), and Galileo. The positioning unit 124 sends a positioning result to the control unit 123, and the control unit 123 evaluates position information about the terminal device 12.

The input unit 125 includes one or more input interfaces. Examples of the input interface include a microphone that accepts a voice input, a physical key, an electrostatic capacitance key, a pointing device, a touch screen that is provided integrally with a display. The input unit 125 accepts a manipulation for inputting information that is used for the operation of the control unit 123, and sends the input information to the control unit 123.

The output unit 126 includes one or more output interfaces. For example, the output interface is a speaker or a display. For example, the display is a liquid crystal display (LCD) or an organic electro-luminescence (EL) display. The output unit 126 outputs information that is obtained by the operation of the control unit 123.

Functions of the control unit 123 are realized by the execution of control and process programs by the processor included in the control unit 123. Each of the control and process programs is a program for causing a computer to execute a process in a step included in the operation of the control unit 123 and thereby causing the computer to realize a function corresponding to the process in the step. That is, each of the control and process programs is a program for causing the computer to function as the control unit 123. Further, some of all of the functions of the control unit 123 may be realized by dedicated circuits included in the control unit 123.

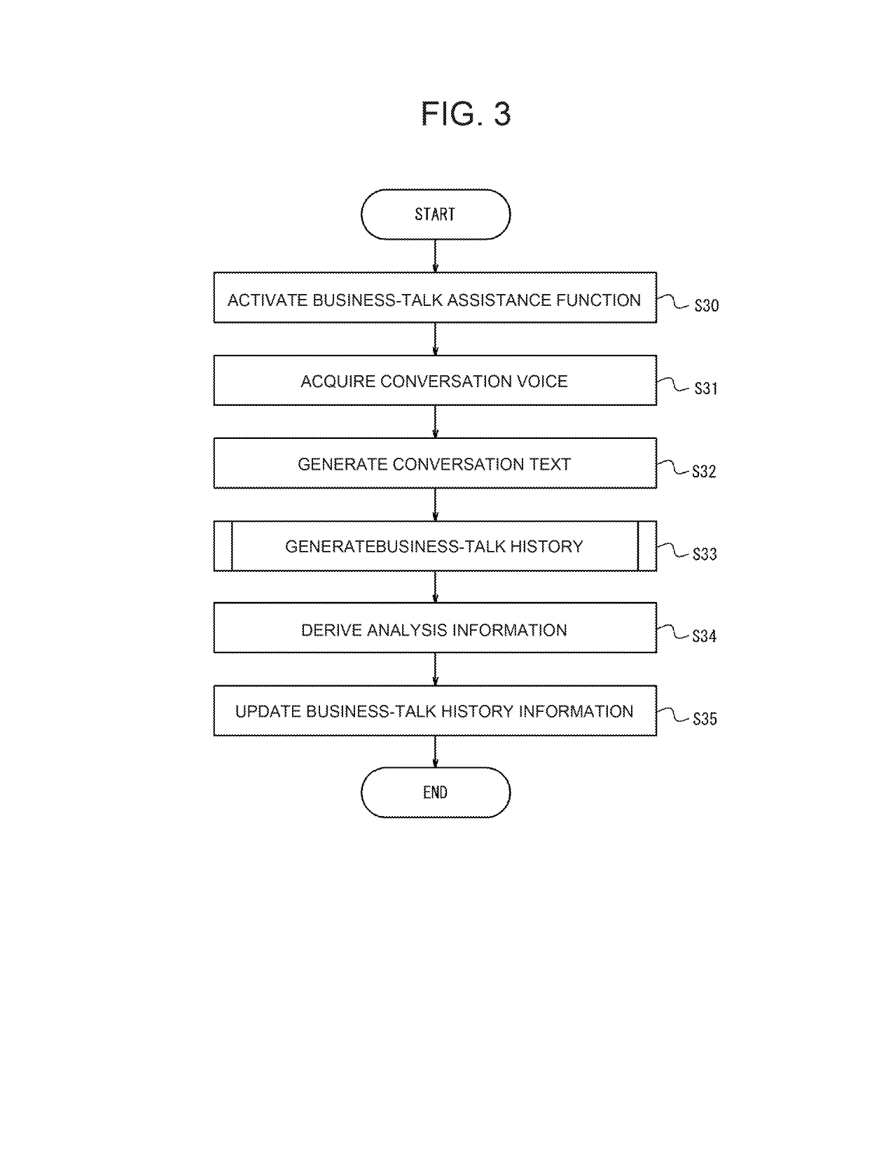

FIG. 3 to FIG. 5 are flowcharts for describing exemplary operations of the server device 10. Each step in FIG. 3 to FIG. 5 is executed by the control unit 103 of the server device 10.

An exemplary procedure in FIG. 3 is an exemplary procedure when the business-talk history information 104 is stored in the server device 10, and is an exemplary procedure that is executed by the control unit 103 of the server device 10 when the user activates a business-talk assistance function of the server device 10 using the terminal device 12. When the person in charge of sales operates the terminal device 12 to request the business-talk assistance function, the terminal device 12 sends an activation request for the assistance function to the server device 10.

In S30, the control unit 103 of the server device 10 acquires the activation request for the assistance function, and then activates the business-talk assistance function in response to the activation request.

In S31, the control unit 103 acquires a conversation audio. When the person in charge of sales performs the business talk with the customer, the audio of the business talk is acquired by the terminal device 12, and then the audio data of the business talk is sent from the terminal device 12 to the server device 10.

In S32, the control unit 103 generates a conversation text about the business talk. For example, when the control unit 103 receives, from the terminal device 12, information indicating the finish of the business talk, for example, information indicating that silence has continued for a certain time or more, the control unit 103 generates the conversation text about the business talk by performing a speech recognition process on the audio data included in the conversation information. At this time, the control unit 103 separates utterances of the person in charge of sales and the customer, by performing a speaking person separation by the extraction of a feature quantity from an audio waveform, the detection of the acoustic change due to the switching of the speaking person, the clustering of the audio data, and the like, and generates respective utterance texts of the person in charge of sales and the customer.

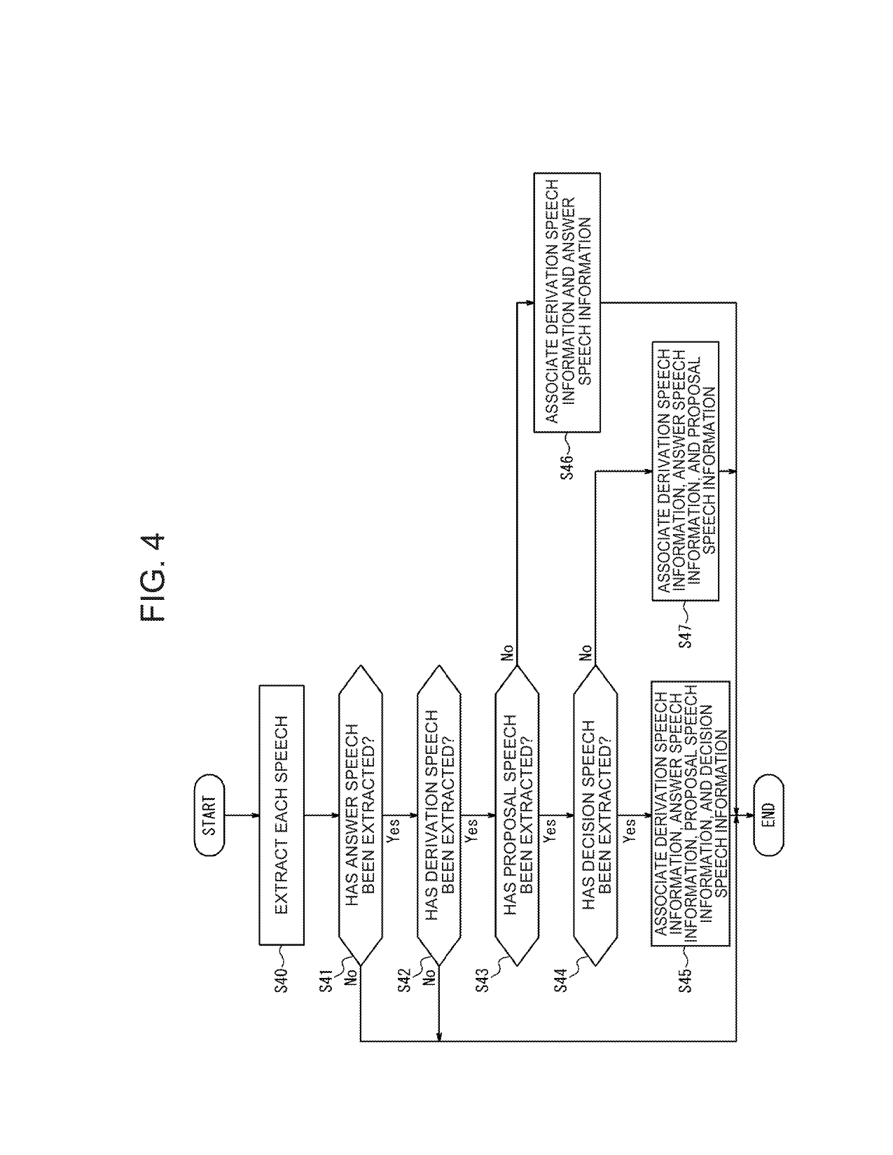

In S33, the control unit 103 generates the business-talk history from the conversation text of the business talk. A detailed procedure of step S33 is shown in FIG. 4.

FIG. 4 is a flowchart showing an exemplary procedure when the control unit 103 generates the business-talk history.

In S40, the control unit 103 extracts each of a derivation utterance, an answer utterance, a proposal utterance, and a decision utterance, from the conversation text about the business talk. The control unit 103 extracts each utterance, by deriving the business-talk date and time from the time stamp of the conversation information and analyzing the conversation text after the speaking person separation, using the LLM 105. Further, the control unit 103 generates a summary of each utterance, using the LLM 105.

The derivation utterance is an utterance that is performed by the person in charge during the business talk for hearing the need of the customer, and includes phrases and contexts for directly asking or indirectly asking with an idle talk, about customer's mind about the purchase, the family configuration, the utilization purpose of the vehicle, hobbies, life events, the living environment, and others.

The answer utterance is an utterance that is performed by the customer during the business talk in response to the derivation utterance, and includes phrases and contexts for expressing customer's mind about the purchase, the family configuration, the utilization purpose of the vehicle, hobbies, life events, the living environment, and others.

The proposal utterance is an utterance that is performed by the person in charge of sales during the business talk for making a proposal depending on the need of the user, and includes phrases and contexts for proposing a vehicle such as a passenger car and a commercial car, an accessary of a vehicle, a maintenance item, a maintenance service for a vehicle, a road service, and others.

The decision utterance is an utterance that is performed by the customer during the business talk for agreeing to or rejecting the purchase of the product or service in response to the proposal from the person in charge of sales, and includes phrases and contexts for expressing an intention to agree to or reject the purchase. The rejection of the purchase includes a case where the customer is in two minds about the purchase.

In S41, the control unit 103 determines whether the answer utterance has been extracted. The control unit 103 proceeds to step S42 in the case where the answer utterance has been extracted (Yes in S41), and ends the procedure in FIG. 4 in the case where the answer utterance has not been extracted (No in S41).

In S42, the control unit 103 determines whether the derivation utterance having derived the answer utterance has been extracted. The control unit 103 proceeds to step S43 in the case where the derivation utterance has been extracted (Yes in S42), and ends the procedure in FIG. 4 in the case where the derivation utterance has not been extracted (No in S42).

In S43, the control unit 103 determines whether the proposal utterance responding to the answer utterance has been extracted. The control unit 103 proceeds to step S44 in the case where the proposal utterance has been extracted (Yes in S43), and proceeds to step S46 in the case where the proposal utterance has not been extracted (No in S43).

In S44, the control unit 103 determines whether the decision utterance responding to the proposal utterance has been extracted. The control unit 103 proceeds to step S45 in the case where the decision utterance has been extracted (Yes in S44), and proceeds to step S47 in the case where the decision utterance has not been extracted (No in S44).

In S45, the control unit 103 generates the business-talk history by associating the derivation utterance information relevant to the derivation utterance, the answer utterance information relevant to the answer utterance, the proposal utterance information relevant to the proposal utterance, and the decision utterance information relevant to the decision utterance, and ends the procedure in FIG. 4.

In S46, the control unit 103 generates the business-talk history by associating the derivation utterance information and the answer utterance information, and ends the procedure in FIG. 4.

In S47, the control unit 103 generates the business-talk history by associating the derivation utterance information, the answer utterance information, and the proposal utterance information relevant to the proposal utterance, and ends the procedure in FIG. 4.

Referring back to FIG. 3, in S34, the control unit 103 derives the analysis information 21. The control unit 103 derives the analysis information 21, by calculating, as the agreement ratio, the ratio of business talks in each of which the decision utterance indicates the agreement to the purchase, for each identical product or service in the business-talk history 20. In the case where the derivation utterance and the answer utterance have not been extracted in step S33, step S34 and step S35 are skipped, and in the case where the proposal utterance or the decision utterance has not been extracted in S33, step S34 is skipped.

In S35, the control unit 103 stores or update the business-talk history information 104 that includes the business-talk history 20 and the analysis information 21. The business-talk history 20 includes at least the derivation utterance information and the answer utterance information, and further includes the proposal utterance information in the case where the proposal utterance has been extracted or further includes the decision utterance information in addition to the proposal utterance information in the case where the decision utterance has been extracted in addition to the proposal utterance. Then, the control unit 103 ends the procedure in FIG. 3.

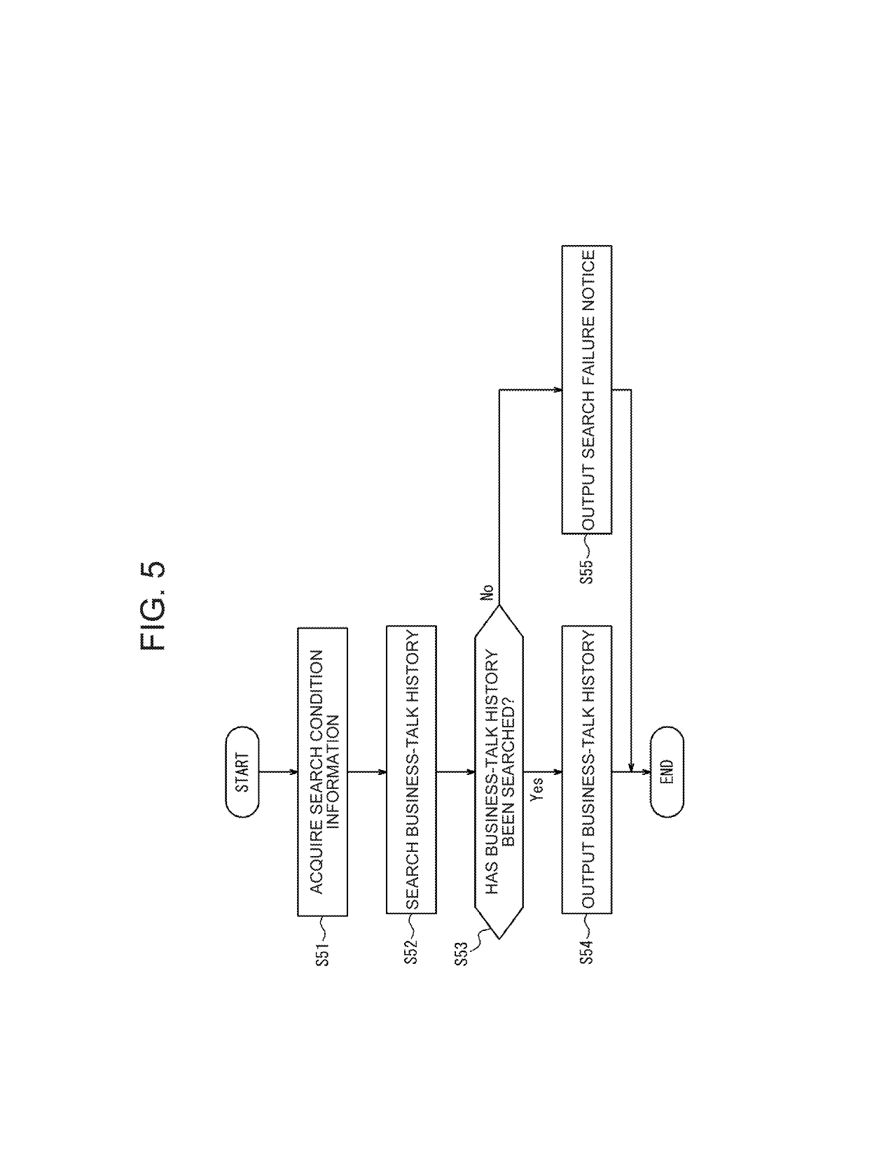

An exemplary procedure in FIG. 5 is an exemplary procedure when the server device 10 searches information corresponding to a search condition from the business-talk history information 104, and is an exemplary procedure that is executed by the control unit 103 of the server device 10 when the user designates the search condition for the server device 10 using the terminal device 12. When the person in charge of sales operates the terminal device 12 to designate the search condition, the terminal device 12 sends information about the search condition to the server device 10. For example, product information previously stored in the terminal device 12 is presented to the user, and the user appropriately perform selection from the presented product information, so that the information about the search condition is designated. Alternatively, the product information may be previously stored in the storage unit 102 of the server device 10, and may be sent from the server device 10 to be presented to the user. The information about the search condition may include the agreement ratio. The user can set an arbitrary agreement ratio by operating the terminal device 12. Alternatively, the search condition may be an arbitrary keyword, for example, a phrase indicating the need of the customer, or other phrases that can be used during the business talk.

In S51, the control unit 103 of the server device 10 acquires the information about the search condition.

In S52, the control unit 103 searches the business-talk history 20 that matches with the search condition, from the business-talk history information 104. In the case where a product is designated as the search condition, the business-talk history 20 when the designated product is proposed is searched. Further, in the case where an agreement ratio is designated as the search condition, the business-talk history 20 when a product having the designated agreement ratio or higher is proposed is searched. Furthermore, in the case where a keyword is designated as the search condition, the business-talk history 20 having an utterance including the designated keyword is searched.

In S53, the control unit 103 determines whether the business-talk history 20 that matches with the search condition has been searched. The control unit 103 proceeds to step S54 in the case where the business-talk history 20 that matches with the search condition has been searched (Yes in S53), and proceeds to step S55 in the case where the business-talk history 20 that matches with the search condition has not been searched (No in S53).

In S54, the control unit 103 outputs the information about the business-talk history 20 to the terminal device 12. In the case where a plurality of business-talk histories 20 is output, the control unit 103 may sort the business-talk histories 20 in descending order of the agreement ratio, or may select and present a business-talk history 20 corresponding to a product having the highest agreement ratio. Then, the control unit 103 ends the procedure in FIG. 5.

In S55, the control unit 103 outputs a notice of search failure to the terminal device 12. Then, the control unit 103 ends the procedure in FIG. 5.

When receiving the information about the searched business-talk history 20, the terminal device 12 outputs, to the user, the derivation utterance information, the answer utterance information, the proposal utterance information, the decision utterance information, the agreement ratio, and others that are included in the business-talk history 20, and on the other hand, when receiving the notice of search failure, the terminal device 12 outputs, to the user, information indicating that there is no business-talk history 20 that matches with the search condition. The user, that is, the person in charge of sales or the mentor thereof can learn, for example, business-talk practice methods by high-skilled persons in charge of sales in the past, by checking the derivation utterance, the answer utterance, the proposal utterance, and the decision utterance that are displayed or are output by voice, for example, or by checking summaries of the derivation utterance, the answer utterance, the proposal utterance, and the decision utterance. Particularly, in the case where the person in charge of sales or the mentor thereof designates a desired agreement ratio, the person in charge of sales or the mentor thereof can learn the practice of the business talk for obtaining the desired agreement ratio. Consequently, it is possible to improve the training efficiency for the person in charge of sales. Alternatively, the person in charge of sales can search the business-talk history in the past, during the execution of the business talk, to utilize the business-talk history in the past for the practice of the business talk.

As a modification, the business-talk history 20 may include identification information about the person in charge of sales that performs the business talk. For example, when the person in charge of sales operates the terminal device 12 to activate the business-talk assistance function, the identification information is sent from the terminal device 12 to the server device 10, and when the business-talk history 20 is generated by the server device 10, the identification information about the person in charge of sales is included in the business-talk history 20. Further, the analysis information 21 may include the agreement ratio for each person in charge of the sales. The person in charge of sales is designated as the search condition using the terminal device 12, and thereby, the utterance information in the business talk in the past by the designated person in charge of sales is searched. Thereby, for example, the practice of the business talk by a person in charge of sales that has good business results can be learned by another inexperienced person in charge of sales. Alternatively, the agreement ratio of the person in charge of sales is designated as the search condition using the terminal device 12, and thereby, the utterance information in the business talk in the past by a person in charge of sales that has the designated agreement ratio or higher is searched.

Some or all of the operations of the server device 10 in the above-described embodiment may be executed by the terminal device 12. In that case, some or all of the business-talk history information 104 may be stored in the storage unit 122 of the terminal device 12, by the acquisition from the server device 10, and some or all of the procedures in FIG. 3 to FIG. 5 may be executed by the control unit 103. In that case, the server device 10 and the terminal device 12 or only the terminal device 12 correspond to the "information processing device" in the embodiment.

In the above-described embodiment, process and control programs that prescribe operations of the terminal device 12 may be stored in the storage unit 102 of the server device 10 or a storage unit of another server device, and may be downloaded in the terminal device 12 via the network 11, or may be stored in a non-transient recording/storing medium that can be read by the terminal device 12 and may be read from the medium by the terminal device 12.

The embodiment has been described above based on the drawings and examples. Note that a person skilled in the art can easily perform various modifications and alterations based on the present disclosure. Accordingly, it is noted that the modifications and the alterations are included in the scope of the present disclosure. For example, functions and others included in means, steps and others can be reallocated such that there is no logical inconsistency, and a plurality of means, steps and others can be combined to one, or can be divided.

Some exemplary embodiments of the present disclosure will be described below. It is noted that embodiments of the present disclosure are not limited to them.

### Supplement 1

An information processing device comprising:

a storage unit configured to associate and store information about a first utterance of a person in charge when the person in the charge hears a need of a customer during a business talk with the customer and information about a second utterance of the customer indicating the need; and

a control unit configured to output the information about the first utterance and the information about the second utterance depending on a search condition.

### Supplement 2

The information processing device according to supplement 1, wherein:

the storage unit further stores information about a third utterance when the person in the charge makes a proposal depending on the need, in association with the information about the first utterance and the information about the second utterance; and

the control unit outputs the information about the third utterance together with the information about the first utterance and the information about the second utterance.

### Supplement 3

The information processing device according to supplement 2, wherein:

the storage unit further stores information about a fourth utterance indicating intention of the customer about the proposal, in association with the information about the first utterance, the information about the second utterance, and the information about the third utterance;

the search condition is a search condition relevant to the intention; and

the control unit outputs the information about the fourth utterance together with the information about the first utterance, the information about the second utterance, and the information about the third utterance.

### Supplement 4

The information processing device according to any one of supplements 1 to 3, wherein:

the information about the first utterance includes an audio of the first utterance extracted from an audio of the business talk by the control unit; and

the information about the second utterance includes an audio of the second utterance extracted from the audio of the business talk by the control unit.

### Supplement 5

The information processing device according to any one of supplements 1 to 4, wherein the control unit generates the information about the first utterance and the information about the second utterance from an audio of the business talk and stores the information about the first utterance and the information about the second utterance in the storage unit.

### Supplement 6

The information processing device according to supplement 2 or 3, wherein the control unit generates the information about the third utterance from an audio of the business talk and stores the information about the third utterance in the storage unit.

### Supplement 7

The information processing device according to supplement 3, wherein the control unit generates the information about the fourth utterance from an audio of the business talk and stores the information about the fourth utterance in the storage unit.

### Supplement 8

An operation method for an information processing device configured to associate and store information about a first utterance of a person in charge when the person in the charge hears a need of a customer during a business talk with the customer and information about a second utterance of the customer indicating the need,

the operation method comprising outputting the information about the first utterance and the information about the second utterance depending on a search condition.

### Supplement 9

The operation method according to supplement 8, wherein:

the information processing device further stores information about a third utterance when the person in the charge makes a proposal depending on the need, in association with the information about the first utterance and the information about the second utterance; and

the operation method further comprises outputting the information about the third utterance together with the information about the first utterance and the information about the second utterance.

### Supplement 10

The operation method according to supplement 9, wherein:

the information processing device further stores information about a fourth utterance indicating intention of the customer about the proposal, in association with the information about the first utterance, the information about the second utterance, and the information about the third utterance;

the search condition is a search condition relevant to the intention; and

the operation method further comprises outputting the information about the fourth utterance together with the information about the first utterance, the information about the second utterance, and the information about the third utterance.

### Supplement 11

The operation method according to any one of supplements 8 to 10, wherein:

the information about the first utterance includes an audio of the first utterance extracted from an audio of the business talk; and

the information about the second utterance includes an audio of the second utterance extracted from the audio of the business talk.

### Supplement 12

The operation method according to any one of supplements 8 to 11, further comprising

generating the information about the first utterance and the information about the second utterance from an audio of the business talk and storing the information about the first utterance and the information about the second utterance.

### Supplement 13

The operation method according to supplement 9 or 10, further comprising

generating the information about the third utterance from an audio of the business talk and storing the information about the third utterance.

### Supplement 14

The operation method according to supplement 10, further comprising

generating the information about the fourth utterance from an audio of the business talk and storing the information about the fourth utterance.

### Supplement 15

A program for an information processing device configured to associate and store information about a first utterance of a person in charge when the person in the charge hears a need of a customer during a business talk with the customer and information about a second utterance of the customer indicating the need, the program causing the information processing device to output the information about the first utterance and the information about the second utterance depending on a search condition.

### Supplement 16

The program according to supplement 15, wherein:

the information processing device further stores information about a third utterance when the person in the charge makes a proposal depending on the need, in association with the information about the first utterance and the information about the second utterance; and

the information processing device further outputs the information about the third utterance together with the information about the first utterance and the information about the second utterance.

### Supplement 17

The program according to supplement 16, wherein:

the information processing device further stores information about a fourth utterance indicating intention of the customer about the proposal, in association with the information about the first utterance, the information about the second utterance, and the information about the third utterance;

the search condition is a search condition relevant to the intention; and

the information processing device further outputs the information about the fourth utterance together with the information about the first utterance, the information about the second utterance, and the information about the third utterance.

### Supplement 18

The program according to any one of supplements 15 to 17, wherein:

the information about the first utterance includes an audio of the first utterance extracted from an audio of the business talk by a control unit; and

the information about the second utterance includes an audio of the second utterance extracted from the audio of the business talk by the control unit.

### Supplement 19

The program according to any one of supplements 15 to 18, wherein

the information processing device generates the information about the first utterance and the information about the second utterance from an audio of the business talk.

### Supplement 20

The program according to supplement 16 or 17, wherein

the information processing device generates the information about the third utterance from an audio of the business talk.

What is claimed is:

1. An information processing device comprising:
a storage unit configured to associate and store information about a first utterance of a person in charge when the person in the charge hears a need of a customer during a business talk with the customer, and information about a second utterance of the customer indicating the need; and
a control unit configured to output the information about the first utterance and the information about the second utterance depending on a search condition.

2. The information processing device according to claim 1, wherein:
the storage unit is configured to further store information about a third utterance when the person in the charge makes a proposal depending on the need, in association with the information about the first utterance and the information about the second utterance; and
the control unit is configured to output the information about the third utterance together with the information about the first utterance and the information about the second utterance.

3. The information processing device according to claim 2, wherein:
the storage unit is configured to further store information about a fourth utterance indicating intention of the customer about the proposal, in association with the information about the first utterance, the information about the second utterance, and the information about the third utterance;
the search condition is a search condition relevant to the intention; and
the control unit is configured to output the information about the fourth utterance together with the information about the first utterance, the information about the second utterance, and the information about the third utterance.

4. The information processing device according to claim 1, wherein:
the information about the first utterance includes an audio of the first utterance extracted from an audio of the business talk by the control unit; and
the information about the second utterance includes an audio of the second utterance extracted from the audio of the business talk by the control unit.

5. The information processing device according to claim 1, wherein the control unit is configured to generate the information about the first utterance and the information about the second utterance from an audio of the business talk and store the information about the first utterance and the information about the second utterance in the storage unit.

6. The information processing device according to claim 2, wherein the control unit is configured to generate the information about the third utterance from an audio of the business talk and store the information about the third utterance in the storage unit.

7. The information processing device according to claim 3, wherein the control unit is configured to generate the information about the fourth utterance from an audio of the business talk and store the information about the fourth utterance in the storage unit.

8. An operation method for an information processing device configured to associate and store information about a first utterance of a person in charge when the person in the charge hears a need of a customer during a business talk with the customer, and information about a second utterance of the customer indicating the need, the operation method comprising outputting the information about the first utterance and the information about the second utterance depending on a search condition.

9. The operation method according to claim 8, further comprising:
storing information about a third utterance when the person in the charge makes a proposal depending on the need, in association with the information about the first utterance and the information about the second utterance; and
outputting the information about the third utterance together with the information about the first utterance and the information about the second utterance.

10. The operation method according to claim 9, further comprising:
storing information about a fourth utterance indicating intention of the customer about the proposal, in association with the information about the first utterance, the information about the second utterance, and the information about the third utterance; and
outputting the information about the fourth utterance together with the information about the first utterance, the information about the second utterance, and the information about the third utterance, wherein the search condition is a search condition relevant to the intention.

11. The operation method according to claim 8, wherein:
the information about the first utterance includes an audio of the first utterance extracted from an audio of the business talk; and
the information about the second utterance includes an audio of the second utterance extracted from the audio of the business talk.

12. The operation method according to claim 8, further comprising generating the information about the first utterance and the information about the second utterance from an audio of the business talk and storing the information about the first utterance and the information about the second utterance.

13. The operation method according to claim 9, further comprising generating the information about the third utterance from an audio of the business talk and storing the information about the third utterance.

14. The operation method according to claim 10, further comprising generating the information about the fourth utterance from an audio of the business talk and storing the information about the fourth utterance.

15. A non-transitory storage medium storing instructions that are executable by one or more processors included in an information processing device and that cause the one or more processors to perform functions, the information processing device being configured to associate and store information about a first utterance of a person in charge when the person in the charge hears a need of a customer during a business talk with the customer, and information about a second utterance of the customer indicating the need, the functions comprising outputting the information about the first utterance and the information about the second utterance depending on a search condition.

16. The non-transitory storage medium according to claim 15, wherein the functions further comprise:
storing information about a third utterance when the person in the charge makes a proposal depending on the need, in association with the information about the first utterance and the information about the second utterance; and
outputting the information about the third utterance together with the information about the first utterance and the information about the second utterance.

17. The non-transitory storage medium according to claim 16, wherein the functions further comprise:
storing information about a fourth utterance indicating intention of the customer about the proposal, in association with the information about the first utterance, the information about the second utterance, and the information about the third utterance; and
outputting the information about the fourth utterance together with the information about the first utterance, the information about the second utterance, and the information about the third utterance, wherein the search condition is a search condition relevant to the intention.

18. The non-transitory storage medium according to claim 15, wherein:
the information about the first utterance includes an audio of the first utterance extracted from an audio of the business talk by a control unit; and
the information about the second utterance includes the audio of the second utterance extracted from the audio of the business talk by the control unit.

19. The non-transitory storage medium according to claim 15, wherein the functions further comprise generating the information about the first utterance and the information about the second utterance from an audio of the business talk.

20. The non-transitory storage medium according to claim 16, wherein the functions further comprise generating the information about the third utterance from an audio of the business talk.
